(19) United States
(12) Patent Application Publication
(10) Pub. No.: US 2025/0059658 A1
(43) Pub. Date: Feb. 20, 2025

(54) A WIND TURBINE WITH AN UP-TOWER ELECTROLYSIS SYSTEM AND A METHOD FOR CONTROLLING THE SYSTEM

(71) Applicant: VESTAS WIND SYSTEMS A/S, Aarhus N (DK)

(72) Inventors: Jesper Rømer HANSEN, Risskov (DK); Alexander REUMERT, Risskov (DK); Torben Ladegaard BAUN, Skødstrup (DK)

(21) Appl. No.: 18/723,286

(22) PCT Filed: Dec. 21, 2022
(86) PCT No.: PCT/DK2022/050305

§ 371 Date: Jun. 21, 2024

(30) Foreign Application Priority Data
Dec. 21, 2021 (DK) PA202170643

(51) Int. Cl. C25B 9/65; C25B 1/04; C25B 15/023; F03D 9/25

(52) U.S. Cl. CPC C25B 9/65; C25B 1/04; C25B 15/023; F03D 9/25; F05B 2220/61

(57) ABSTRACT

A wind turbine comprising a tower, a nacelle mounted rotatably on the tower via a yaw system and a hub carrying at least one wind turbine blade is disclosed. The wind turbine comprises a generator, an AC/DC converter connected to the generator and an electrolysis system connected to a DC power output of the AC/DC converter for producing hydrogen, the electrolysis system being arranged in an up-tower part of the wind turbine. A hydrogen transport line is connected to the electrolysis system for transporting hydrogen produced by the electrolysis system away from the electrolysis system, the hydrogen transport line extending in an interior part of the tower at least partly between the up-tower part of the wind turbine and a lower part of the tower. At least one hydrogen sensor are arranged in the interior part of the tower.

### FIELD OF THE INVENTION

The present invention relates to a wind turbine comprising a tower, a nacelle and a hub carrying at least one wind turbine blade. The wind turbine of the invention further comprises an electrolysis system for generating hydrogen by means of electrical power produced by the wind turbine. The invention further relates to a method for operating an electrolysis system and a hydrogen transport line forming part of a wind turbine.

### BACKGROUND OF THE INVENTION

As production of renewable electrical energy, e.g. using wind turbines or photovoltaic panels, increases, there is a need for converting some of the produced electrical energy into other kinds of energy which allow storage of the energy as well as allow the energy to be used for purposes where electrical energy is not suitable, e.g. fuel for freight ships, aircrafts, trucks, etc. This conversion of electrical energy is sometimes referred to as ‘power to X’.

One widespread way of converting electrical energy into another kind of energy is to apply the electrical energy for driving an electrolysis system, thereby producing hydrogen from water. The hydrogen may then be stored, possibly after being transported to a suitable storage position via a pipeline or suitable transport vessels. The hydrogen may be used directly as fuel, or it may be used for producing other suitable products of high energy content, such as for example methane, ethanol or ammonia.

When applying electrical energy produced by wind turbines for producing hydrogen via electrolysis, the electrical energy is often supplied to a central facility, for example in the form of a substation or a so-called ‘energy island’, which receives electrical energy from several wind turbines, e.g. from several wind farms. This requires that the electrical energy is transported in the form of AC power, in order to minimise losses during transport. Therefore, the wind turbines are normally provided with a converter in the form of an AC/DC converter connected to the generator of the wind turbine, a DC/AC converter connected to the power grid, and a DC link interconnecting the AC/DC converter and the DC/AC converter. The AC/DC converter is sometimes referred to as a generator side converter, and the DC/AC converter is sometimes referred to as a grid side converter. The grid side converter will often be more expensive than the generator side converter.

In order to avoid transporting the electrical energy from the wind turbine to a central facility, it may be desirable to position an electrolysis system locally at or in the wind turbine. However, this introduces a potential safety hazard if hydrogen escapes and becomes present in interior parts of the wind turbine.

### DESCRIPTION OF THE INVENTION

It is an object of embodiments of the invention to provide a wind turbine with an electrolysis system which is cost effective to manufacture and safe to operate.

It is a further object of embodiment of the invention to provide a method for operating an electrolysis system and a hydrogen transport line forming part of a wind turbine in a cost effective and safe manner.

According to a first aspect the invention provides a wind turbine comprising a tower, a nacelle mounted rotatably on the tower via a yaw system and a hub carrying at least one wind turbine blade, the hub being mounted rotatably on the nacelle, the wind turbine further comprising a generator, an AC/DC converter connected to the generator and an electrolysis system connected to a DC power output of the AC/DC converter for producing hydrogen, the electrolysis system being arranged in an up-tower part of the wind turbine, wherein the wind turbine further comprises a hydrogen transport line connected to the electrolysis system for transporting hydrogen produced by the electrolysis system away from the electrolysis system, the hydrogen transport line extending in an interior part of the tower at least partly between the up-tower part of the wind turbine and a lower part of the tower, the wind turbine further comprising at least one hydrogen sensor arranged in the interior part of the tower.

Thus, according to the first aspect, the invention provides a wind turbine, i.e. a structure which is capable of extracting energy from the wind and convert it into electrical energy. The wind turbine comprises a tower, a nacelle mounted rotatably on the tower, and a hub. The tower extends between a base part, which is connected to a foundation, a monopile, a transition piece, or any other suitable kind of structure which connects the wind turbine to the position where it is located, and an upper part to which the nacelle is connected.

The hub carries at least one wind turbine blade, and is mounted rotatably on the nacelle. Accordingly, wind acting on the wind turbine blades causes the hub to rotate, and the wind turbine blades will rotate along. The hub and the wind turbine blades form a rotor.

The nacelle is mounted on the tower via a yaw system, thereby allowing the nacelle to rotate relative to the tower in order to appropriately align the rotor with respect to the direction of the incoming wind. In the case that the wind turbine is an upwind wind turbine, the yaw system is operated in order to direct the rotor towards the incoming wind. In the case that the wind turbine is a downwind wind turbine, the yaw system is operated in order to direct the rotor opposite to the direction of the incoming wind.

The wind turbine further comprises a generator, operatively connected to the rotating hub, optionally via a gear arrangement, for generating electrical energy from the rotating movements of the hub. An AC/DC converter is connected to the generator, and an electrolysis system for producing hydrogen is connected to the DC power output of the AC/DC converter. An AC/DC converter is sometimes referred to as a rectifier. Accordingly, the electrolysis system forms part of the wind turbine. The AC power produced by the generator is converted into DC power by the AC/DC converter, and the DC power is supplied directly to the electrolysis system. Thus, the electrolysis system is arranged close (such as within less than for example 5-20 m) to the source of the electrical energy, and it is not necessary to convert the DC power into AC power with a suitable grid compliant frequency in order to be able to transfer the power over a long distance to a central facility and particularly not required that the electricity produced follow other stringent grid quality requirements. Thereby the DC/AC converter can be omitted, thereby saving manufacturing costs. Furthermore, power losses due to power conversion and transport are avoided or reduced during use.

The electrolysis system is arranged in an up-tower part of the wind turbine. In the present context the term ‘up-tower part’ should be interpreted to mean a part of the wind turbine which is at or near a top of the tower, and thereby close to the generator, which is normally arranged in the nacelle. The up-tower part of the wind turbine may, thus, be inside the nacelle, in a compartment mounted to the nacelle, inside the tower or mounted on an outside surface of the tower immediately below the nacelle, e.g. within the upper ¼ of the tower where blade clearance from the tower is sufficient to allow safe space for such a compartment. Accordingly, the production of hydrogen takes place at the up-tower part of the wind turbine, and thereby at a distance from the base part of the tower.

The hydrogen may be transported as hydrogen gas or hydrogen may converted up-tower into another energy carrier, such as for example ammonia, methanol, ethanol, or incorporated in a liquid organic hydrogen carrier (LOHC) before being transported. Hence, in the context of the present invention, hydrogen refers to both hydrogen gas and hydrogen incorporated in another energy carrier or in a liquid organic hydrogen carrier. Most advantages of the various embodiments disclosed herein concerns both hydrogen gas and hydrogen incorporated in ammonia, ethanol or LOHC. However, some advantages concern only hydrogen gas or are particularly advantageous for hydrogen gas and hence it is preferred that the hydrogen is in the form of hydrogen gas.

The wind turbine further comprises a hydrogen transport line connected to the electrolysis system for transporting hydrogen produced by the electrolysis system away from the electrolysis system, e.g. towards a pipeline, a suitable storage tank, etc. The hydrogen transport line extends in an interior part of the tower at least partly between the up-tower part of the wind turbine and a lower part of the tower. Thereby the hydrogen transport line is protected, by means of the wall of the tower, from environmental impact, such as strong winds, precipitation, salty air, lightning, wildlife, other moving objects, passing wind turbine blades, etc. Furthermore, by arranging the hydrogen transport line in the interior part of the tower, it can be ensured that the nacelle is able to perform yawing movements relative to the tower without damaging the hydrogen transport line.

The wind turbine further comprises at least one hydrogen sensor arranged in the interior part of the tower. When arranging a transport line for transporting hydrogen within the confined space of a wind turbine tower, this may introduce a risk of fire and explosions in the case that the hydrogen transport line leaks or is damaged. In this case, hydrogen will enter the interior of the tower and May accumulate there, possibly leading to accumulated hydrogen being mixed with the oxygen of the air, and in the case that such a mixture is ignited, it may cause a fire or even an explosion. Thus, by arranging at least one hydrogen sensor in the interior part of the tower, it can immediately be detected if hydrogen is leaking from the hydrogen transport line into the interior of the tower, and thereby suitable measures can be taken in time for preventing fire or explosion.

Preferably, at least one hydrogen sensor is arranged in an upper part of the tower. Since hydrogen gas is lighter than atmospheric gas, it will naturally ascent, and therefore it will be most likely to accumulate in the upper part of the tower. Accordingly, by arranging a hydrogen sensor in this part of the tower, it is efficiently ensured that a hydrogen leak is detected, even if the hydrogen concentration in the tower is low.

The wind turbine may comprise two or more hydrogen sensors. In this case the hydrogen sensors may be distributed along the length of the tower, thereby allowing for detection of the presence of hydrogen at various levels inside the tower. This may, e.g., allow a position of a leak in the hydrogen transport line to be located and precaution action be taken locally for improved efficiency.

Thus, the hydrogen transport line is protected by the walls of the tower, while the risk of possible hydrogen leaks leading to fire or explosion inside the tower is minimised, due to the hydrogen sensors, despite the energy optimal up-tower position of the electrolysis system.

Thus, the wind turbine according to the invention allows production of hydrogen in a cost effective and safe manner, in particular in a manner which significantly reduces the risk for personnel and equipment of fire and explosions in the wind turbine, notably in the tower, as well as risk of suffocation.

The hydrogen transport line may be provided with a one-way valve (also referred to as a check valve) arranged at an outlet of the hydrogen transport line, at a lower part of the tower. The one-way valve allowing hydrogen to leave the hydrogen transport line towards an external hydrogen grid or (local) storage facility, but preventing hydrogen from the external hydrogen grid or storage from entering the hydrogen transport line.

According to this embodiment, a one-way valve or a check valve is arranged at an interface between the hydrogen transport line and an external hydrogen grid or (local) storage facility. According to this embodiment, when the system is fully operational and the electrolysis system produces hydrogen, the produced hydrogen is supplied to the external hydrogen grid, via the hydrogen transport line and the one-way valve. However, if for some reason the electrolysis system is not producing hydrogen, and/or the hydrogen transport line is not transporting hydrogen, then the one-way valve prevents that hydrogen from the external hydrogen grid enters the hydrogen transport line. Accordingly, the one-way valve seals off the hydrogen transport line in situations where it is not required to deliver hydrogen from the hydrogen transport line to the external hydrogen grid.

This could, e.g., be relevant in the case that the electrolysis system has been stopped, e.g. due to a detected hydrogen leak or due to lack of power production by the wind turbine. Furthermore, this could be relevant before installation of the wind turbine has been completed. For instance, this will allow for use of the external hydrogen grid before all wind turbines of a wind farm which are intended to supply hydrogen to the external hydrogen grid have been installed.

Particularly, it was found to be advantageous that the one-way valve is arranged in a part of the hydrogen transport line which is arranged outside the tower wall. This was found to allow for a combined design of tower and hydrogen transport line with no connections in the hydrogen transport line inside the tower, which reduced the risk of hydrogen leakage. Furthermore, hydrogen from the external hydrogen grid is prevented from entering the interior part of the tower.

The wind turbine may further comprise at least one blast panel formed in a wall of the tower, each blast panel being provided in a part of the tower wall which is provided with a reinforcement rim arranged circumferentially with respect to the blast panel.

According to this embodiment, in the case that leaking hydrogen in the interior part of the tower causes an explosion in the tower, this will cause the blast panels to blow out, but the rest of the wind turbine, in particular the rest of the tower, will remain essentially unaffected. The tower wall is provided with reinforced rims arranged circumferentially with respect to each of the blast panels, A) to ensure that the structural capability of the tower remains sufficient despite the intended weakness of the blast panels, and/or B) to ensure that the structural integrity of the tower remains essentially intact, even if the blast panels have been blown out. This significantly reduces the risk of severe structural damage to the tower in the case of an explosion. Particularly, the reinforcement may allow for a controlled repair, decommissioning or dismantling of the wind turbine after an incident that would otherwise not be feasible in a safe manner.

An access door arranged in the lower part of the tower may form one of the blast panels, and a door frame of the access door may form a reinforced rim.

The wind turbine may further comprise at least one controllable valve arranged between the electrolysis system and an inlet of the hydrogen transport line.

According to this embodiment, the connection between the electrolysis system and the hydrogen transport line can be closed or sealed off by closing the controllable valve. Thereby hydrogen produced by the electrolysis system is prevented from entering the hydrogen transport line, and thereby the interior part of the tower. This may, e.g., be relevant in the case that a hydrogen leak is detected in the interior part of the tower. In this case it is desirable to prevent further hydrogen from entering the hydrogen transport line, and sealing off the supply from the electrolysis system can be performed fast and efficiently by means of the controllable valve. Similarly, a leak in the electrolysis system balance of plant such as dryer, de-oxygenizer, demister and optional conversion system for binding hydrogen to a LOHC or convert into another energy carrier may lead to hydrogen being transported backwards from the hydrogen transport line to the electrolysis system and it would be highly advantageous to be able to seal off the electrolyser system to prevent this. Particularly, it was found to be advantageous that the controllable valve is arranged in a part of the hydrogen transport line which is arranged outside the tower wall. This was found to allow for a combined design of tower and hydrogen transport line with no connections in the hydrogen transport line inside the tower, which reduced the risk of hydrogen leakage. Accordingly, the controllable valve may be controlled based on sensor readings from the at least one hydrogen sensor arranged in the interior part of the tower, e.g. by automatically closing the valve if the hydrogen level inside the tower exceeds a predefined threshold value and/or if the rate of change in hydrogen level inside the tower exceeds a predefined threshold value.

A further controllable valve may be arranged at the outlet of the hydrogen transport line at or near the lower part of the tower. In this case it is possible to completely isolate the hydrogen transport line from any possible sources of hydrogen, in a fast and efficient manner, thereby preventing further hydrogen from entering the interior part of the tower in the case of a leak in the hydrogen transport line.

The wind turbine may further comprise an emergency hydrogen exit channel connected directly to the electrolysis system and/or the hydrogen transport line. According to this embodiment, it is possible to vent hydrogen from the electrolysis system and the hydrogen transport line to the ambient atmosphere, via the emergency hydrogen exit channel. This may, e.g., be relevant in the case that the electrolysis system has been stopped, e.g. due to an emergency, such as a detected hydrogen leak. In this case it may be desirable that any hydrogen remaining in the system, including in the electrolysis system and the hydrogen transport line, is conveyed out of the wind turbine or at least that the pressure of the hydrogen in the electrolysis system and hydrogen transport line is reduced or completely released, thereby preventing hydrogen accumulation inside the wind turbine, notably inside the tower. It was found to be particularly advantageous to have an emergency hydrogen exit channel when the wind turbine also comprises a valve between transport line and electrolyser. This allows for venting one after the other or—in case a leak arise—to may allow to preserve the gas in one part without having to lose it to allow for the leak to be repaired.

The emergency hydrogen exit channel may, e.g., be operated based on sensor signals from the at least one hydrogen sensor and/or based on an operational status of the electrolysis system, in such a manner that the emergency hydrogen exit channel remains closed under normal operation of the electrolysis system, and as long as no hydrogen leak is detected, whereas the emergency hydrogen exit channel is opened in the case that the electrolysis system is stopped and/or a hydrogen leak is detected. The emergency hydrogen exit channel may be equipped with a flaring mechanism, so hydrogen released via the exit channel is combusted. This is primarily relevant when the hydrogen is bound in for example ammonia, ethanol, or incorporated in a liquid organic hydrogen carrier (LOHC).

The emergency hydrogen exit channel may, e.g., be formed in the nacelle, e.g. in a roof part of the nacelle with exit above the roof and/or behind the nacelle in the wind direction. As described above, hydrogen will naturally ascent, and therefore an emergency hydrogen exit channel formed in the roof of the nacelle will automatically lead the hydrogen out of the wind turbine and towards the ambient atmosphere.

The wind turbine may further comprise at least one controllable venting blower arranged at a venting opening formed in a wall of the tower, in the nacelle and/or in the compartment of the electrolysis system. The venting opening may preferably be remotely and/or automatically actuated, such as actuated in response to a sensor reading.

According to this embodiment, the tower, the nacelle and/or the compartment comprising the electrolysis system is provided with at least one venting opening, and controllable venting blowers are arranged at the venting openings. Thereby, in the case that venting of the interior part of the wind turbine is required, at least one of the venting blower can be operated in order to cause ventilation, i.e. to cause air inside the tower to be vented out of the tower, via the respective venting openings.

According to this embodiment, the tower is provided with at least one venting opening, and controllable venting blowers are arranged at the venting openings. Thereby, in the case that venting of the interior part of the tower is required, at least one of the venting blower can be operated in order to cause ventilation, i.e. to cause air inside the tower to be vented out of the tower, via the respective venting openings.

The venting blowers may be controllable in the sense that they may be started or stopped in accordance with certain criteria. Furthermore, the speed of the venting blowers may be adjustable or controllable, thereby allowing control of an air flow through the respective venting openings. Corresponding openings for air to enter the wind turbine may be equipped with desalination and/or dehumidifiers. For offshore wind turbines, it was found to be advantageous to arrange the venting blowers so air is transported downwards through the tower and openings for air to enter the wind turbine is arranged close to the top of the wind turbine tower as this reduces the salt and humidity content in the venting air.

The controllable venting blowers may, e.g., be controlled based on sensor signals from the at least one hydrogen sensor arranged in the interior part of the tower. Operation of the venting openings or venting blowers may allow to reduce or keep hydrogen level sufficiently low that operation of the wind turbine and electrolyser may continue for extended time before repair (to allow for improved repair/maintenance planning or even during repair.

The hydrogen transport line may be or comprise a double walled pipe, forming an inner pipe part in which hydrogen is transported and an outer pipe part arranged circumferentially with respect to the inner pipe part.

According to this embodiment, the hydrogen is transported in an inner pipe, which is enclosed in an outer pipe. Thereby, in the case that a leak occurs in the inner pipe, the hydrogen will enter the space between the inner pipe and the outer pipe, instead of entering the interior part of the tower. Thereby the presence of hydrogen, in particular H₂, in the tower is reduced. This is an advantage because the presence of hydrogen may make steel brittle over time.

At least one hydrogen sensor may be arranged to measure gas in the outer pipe, i.e. in the space between the inner pipe and the outer pipe. Thereby a leak in the inner pipe can be detected fast, and actions can be taken before hydrogen enters the interior part of the tower.

A venting gas may be present in the space between the inner pipe and the outer pipe, e.g. in order to ensure that any hydrogen leaking from the inner pipe is vented out of the outer pipe. The venting gas may be atmospheric air. Alternatively, the venting gas may be an inert gas, such as nitrogen. One advantage of applying an inert gas as venting gas is that, in the case that the inner pipe breaks at a position near the bottom of the tower, there is a risk that the gas present in the space between the inner pipe and the outer pipe is sucked into the inner pipe, and thereby into the hydrogen stream. In the case that the venting gas is atmospheric air, this introduces a risk that oxygen is introduced into the hydrogen stream, thereby introducing a risk of fire or explosion. However, in the case that the venting gas is an inert gas, such a risk of fire or explosion is not introduced.

The wind turbine may further comprise an emergency flushing system for flushing the outer pipe part with a venting gas in the case of a hydrogen leak from the inner pipe part.

According to this embodiment, the outer pipe is actively flushed with a venting gas in the case that a hydrogen leak from the inner pipe is detected, thereby efficiently preventing that hydrogen enters the interior of the tower. This could, e.g., include operating blowers for driving the venting gas through the outer pipe for release to outside the wind turbine.

As described above, the venting gas may be atmospheric air or an inert gas, such as nitrogen.

As an alternative to flushing the outer pipe, the entire tower may be flushed with a venting gas.

The electrolysis system may be arranged inside the nacelle or in a closed, closable or sealable compartment connected to the nacelle.

According to this embodiment, the electrolysis system is arranged close to the generator and the AC/DC converter, which are normally both arranged in the nacelle. This is particularly the case if the electrolysis system is arranged inside the nacelle. Furthermore, by arranging the electrolysis system inside the nacelle the electrolysis system is arranged within a part of the wind turbine which is already there for housing other components of the wind turbine, and the electrolysis system is shielded by the outer walls of the nacelle.

In the case that the electrolysis system is arranged in a closed, closable or sealable compartment connected to the nacelle, the electrolysis system is arranged inside a compartment which can be separated or isolated from the interior of the nacelle. Thereby the risk of hydrogen leaking inside the nacelle is significantly reduced which reduces the risk for personnel and equipment of fire and explosions in the wind turbine, notably in the nacelle. The compartment may form part of the nacelle but be separated in a sealable manner allowing no access for hydrogen from the compartment to the main part of the nacelle during operation of the electrolysis system.

The compartment housing the electrolysis system may be completely closed towards the nacelle. As an alternative, at least one gas sealable door, hatches or the like may be provided between the interior of the nacelle and the compartment, in order to provide access to the electrolysis system, e.g. for maintenance personnel.

The compartment(s) may, e.g., be connected to the nacelle along the sides of the nacelle extending between a front surface where the hub is mounted on the nacelle and a rear surface arranged opposite thereto. As an alternative, the compartment(s) may be connected to the nacelle along the rear surface, along a top surface or along a bottom surface at a position which is non-overlapping with the interface between the tower and the nacelle.

When the electrolysis system is arranged inside the nacelle or in a compartment connected thereto, it rotates along with the nacelle when the nacelle performs yawing movements so yawing capable electrical transport of high power cables may be avoided. However, the hydrogen transport line passes the yaw system, and thereby parts which move relative to each other.

A part of the hydrogen transport line which passes the yaw system may be arranged outside the tower and the nacelle. According to this embodiment, the part of the hydrogen transport line which passes parts of the wind turbine which move relative to each other is arranged outside the wind turbine. Even thou arranging this part of the hydrogen transport line outside the tower and the nacelle poses an increase level of complexity (as the hydrogen transport line needs to transfer from inside nacelle to outside and thereafter to inside the tower, this was found to be highly advantageous since in the case that the hydrogen transport line is damaged, due to the mutually moving parts, then the potentially resulting leak in the hydrogen transport line occurs outside the wind turbine, and thereby the hydrogen leaks directly to the ambient atmosphere, thereby preventing accumulation of hydrogen inside the wind turbine.

As an alternative, the hydrogen transport line may pass through the yaw system, in an interior part thereof. For instance, the yaw system may be provided with a transport line guiding mechanism for guiding the hydrogen transport line past the yaw system from the nacelle to the interior part of the tower, in a manner which allows the nacelle to perform yawing movements relative to the tower.

The transport line guiding mechanism may comprise a cable chain. In the present context the term ‘cable chain’ should be interpreted to mean a chained structure designed for accommodating a flexible cable, hose or the like, in a manner which allows the cable or hose to be winded and un-winded as a part, which the cable or hose is connected to, moves. Cable chains may also be referred to as cable carriers, drag chains or energy chains.

Thus, cable chains are suitable for guiding the hydrogen transport line past the yaw system, while protecting the hydrogen transport line and allowing appropriate operation of the yaw system.

As an alternative, the transport line guiding mechanism may comprise a cable trolley, or any other suitable kind of guiding mechanism.

The hydrogen transport line may comprise a coiled portion, and a diameter of the coiled portion may change in response to yawing movements of the nacelle.

According to this embodiment, a part of the hydrogen transport line arranged in the interior part of the tower is arranged in a coiled configuration, i.e. the hydrogen transport line follows a spiral shaped path or similar. When the nacelle performs yawing movements relative to the tower, the part of the hydrogen transport line which is connected to the electrolysis system will rotate along. This rotating movement is transferred to the coiled portion of the hydrogen transport line. When the yawing movements are performed along a first direction, this will cause the coiled portion to be coiled tighter, thereby decreasing the diameter of the coiled portion. When the yawing movements are performed along a second, opposite, direction, the coiled portion will be coiled in a less tight manner, thereby increasing the diameter of the coiled portion. Accordingly, the coiled portion ‘absorbs’ potential tensions in the hydrogen transport line arising from the yawing movements, thereby reducing the risk of damage to the hydrogen transport line. It was found that the central axis of the coil preferably may be arranged parallel to the longitudinal axis of the tower and more preferably the central axis of the coil coincide with longitudinal axis of the tower.

As an alternative to arranging the electrolysis system inside the nacelle or in a compartment connected thereto, the electrolysis system may be arranged in an upper part of the tower, e.g. in the upper ¼ of the tower.

The wind turbine may further comprise a hydrogen warning indicator arranged at a door opening at the lower part of the tower and/or a door between the nacelle and a compartment comprising the electrolysis system, the hydrogen warning indicator being activated in case of hydrogen detection in the interior part of the tower. This is particularly important since opening/closing of doors may create sparks and particularly if the door is designed a blast panel (as described elsewhere herein) this may pose a risk that the door may blow out and harm personnel when entering the wind turbine or compartment with excessive hydrogen gas content in the air.

According to this embodiment, in the case that presence of hydrogen inside the tower is detected by means of the at least one hydrogen sensor, a warning system is activated, including activating a hydrogen warning indicator arranged at a door opening at the lower part of the tower. Thereby personnel is warned against entering the tower or compartment via the door opening, when conditions inside the tower are considered unsafe, due to the detected hydrogen presence. As described above, the detected hydrogen presence may be in the form of a detected hydrogen level and/or in the form of a rate of change in hydrogen level.

The hydrogen warning indicator may be visual, e.g. in the form of a lamp which is turned on, possibly a flashing lamp. Alternatively or additionally, the warning indicator may be audible, e.g. in the form of a siren or a loudspeaker. The warning indicator is preferably visible and/or audible from outside the wind turbine, in order to prevent personnel from entering the wind turbine if this is considered unsafe.

When the hydrogen warning indicator is activated, this may further cause an automatic lock on the door to be activated, thereby locking the door and preventing personnel from entering the interior part of the wind turbine from the outside, via the door opening. However, when the door is automatically locked in this manner, it should still be possible to open the door from the inside, in order to allow personnel already present inside the wind turbine when the hydrogen warning indicator is activated to escape.

According to a second aspect the invention provides a method for operating an electrolysis system and a hydrogen transport line forming part of a wind turbine, the wind turbine comprising a tower, a nacelle mounted rotatably on the tower via a yaw system, a generator and an AC/DC converter connected to the generator, the electrolysis system being arranged in an up-tower part of the wind turbine and being connected to a DC power output of the AC/DC converter, the hydrogen transport line extending in an interior part of the tower at least partly between the up-tower part of the wind turbine and a lower part of the tower, the method comprising the steps of:
producing hydrogen by means of the electrolysis system using DC power produced by the wind turbine and supplied to the electrolysis system from the DC power output of the AC/DC converter, and transporting the produced hydrogen from the electrolysis system towards a lower part of the tower by means of the hydrogen transport line arranged in the interior part of the tower,
monitoring a hydrogen level in the interior part of the tower by means of at least one hydrogen sensor arranged in the interior part of the tower, and
in the case that a hydrogen level exceeding a first threshold level and/or a rate of change in hydrogen level exceeding a second threshold level is detected, initiating an emergency procedure, the emergency procedure comprising the step of stopping production of hydrogen by means of the electrolysis system.

Thus, the method according to the second aspect of the invention is a method for operating an electrolysis system and a hydrogen transport line forming part of a wind turbine, the hydrogen transport line extending in an interior part of the tower of the wind turbine. The wind turbine may, e.g., be a wind turbine according to the first aspect of the invention, and the remarks set forth above are therefore equally applicable here.

Accordingly, a person skilled in the art would readily recognise that any feature described in combination with the first aspect of the invention could also be combined with the second aspect of the invention, and vice versa.

In the method according to the second aspect of the invention, hydrogen is produced by means of the electrolysis system using DC power produced by the wind turbine and supplied to the electrolysis system from the DC power output of the AC/DC converter. As described above with reference to the first aspect of the invention, this allows hydrogen to be produced in a cost effective manner, and with minimal power loss.

The produced hydrogen is transported from the electrolysis system towards a lower part of the tower by means of the hydrogen transport line arranged in the interior part of the tower. As described above with reference to the first aspect of the invention, this ensures that the hydrogen transport line is protected by the wall of the tower.

A hydrogen level in the interior part of the tower is monitored by means of the at least one hydrogen sensor arranged in the interior part of the tower. This may include monitoring a hydrogen concentration and/or monitoring a rate of change of hydrogen concentration. For instance, a rapidly increasing hydrogen concentration may be an indication of a leak in the hydrogen transport line, whereas an increase in the rate of change may be an indication that the source of the leak is evolving and may become detrimental over time. In the case that the wind turbine comprises two or more hydrogen sensors arranged at various levels inside the tower, a position of a leak in the hydrogen transport line may be determined by comparing the measurements performed by the sensors to each other, since it may be assumed that a sensor positioned close to the leak will detect an increase in hydrogen concentration earlier, and possibly more profoundly, than a sensor positioned further away from the leak.

In the case that a hydrogen level exceeding a first threshold level and/or a rate of change in hydrogen level exceeding a second threshold level is detected, this may be an indication that the presence of hydrogen inside the tower is at an unsafe level, or approaching an unsafe level or the cause of a leak is evolving. Therefore, an emergency procedure is initiated.

The emergency procedure comprises the step of stopping production of hydrogen by means of the electrolysis system. Accordingly, in the case that an increased hydrogen level and/or rate of change of hydrogen level is detected inside the tower, the production of hydrogen, and thereby the source of hydrogen, is stopped. Thus, in the case that the increased hydrogen level and/or rate of change of hydrogen level is due to a leak in the hydrogen transport line, it is ensured that the supply of hydrogen to the hydrogen transport line, and thereby to the leak, is stopped. Accordingly, the increase in hydrogen level inside the tower is efficiently stopped.

The emergency procedure may further comprise the step of closing a controllable valve arranged between the electrolysis system and an inlet of the hydrogen transport line, thereby preventing hydrogen from entering the hydrogen transport line from the electrolysis system.

Even if the production of hydrogen by means of the electrolysis system is stopped, there may be residual hydrogen in the electrolysis system and/or in a line or pipe leading from the electrolysis system towards the part of the hydrogen transport line which is arranged in the interior part of the tower. By closing a controllable valve arranged between the electrolysis system and an inlet of the hydrogen transport line, it is ensured that such residual hydrogen is prevented from entering the hydrogen transport line, and thereby the interior part of the tower, via a potential leak in the hydrogen transport line. Accordingly, this also limits the potential increase in hydrogen level inside the tower.

The emergency procedure may further comprise the step of opening an emergency hydrogen exit channel connected directly to the electrolysis system and/or the hydrogen transport line, thereby venting any residual hydrogen including pressurized hydrogen from the electrolysis system and the hydrogen transport line to the ambient atmosphere, optionally followed by flushing the electrolysis system and/or the hydrogen transport line by an inert gas, such as nitrogen.

According to this embodiment, it is ensured that any residual hydrogen remaining in the electrolysis system when production of hydrogen has been stopped is vented out of the wind turbine, and thereby prevented from entering the hydrogen transport line, and potentially the interior of the tower via a possible leak in the hydrogen transport line. Accordingly, this also stops the increase in hydrogen level inside the tower. Furthermore, this is a fast and efficient way of removing residual hydrogen from the system.

The emergency hydrogen exit channel may preferably have an outlet arranged in the nacelle, preferably in or near the roof of the nacelle. Since hydrogen tends to ascent, this will naturally ensure that the residual hydrogen leaves the wind turbine towards the ambient atmosphere.

The emergency hydrogen exit channel may be connected to the electrolysis system as well as to the hydrogen transport line. In this case, any residual hydrogen in the hydrogen transport line is also vented out of the wind turbine, via the emergency hydrogen exit channel.

The emergency procedure may further comprise controlling a blower speed of at least one controllable venting blower arranged at venting openings formed in a wall of the tower, thereby venting the interior part of the tower.

According to this embodiment, the interior part of the tower is vented as part of the emergency procedure, by appropriately operating venting blowers arranged at venting openings formed in the wall or the tower, thereby decreasing the hydrogen level inside the tower. For instance, venting blowers at relevant positions along the length of the tower may be activated, and/or the blower speed of the blowers may be adjusted. The venting blowers may be controlled based on measurements from the one or more hydrogen sensor arranged in the interior part of the tower. For instance, venting blowers arranged at positions which correspond to positions of hydrogen sensors which measure an elevated hydrogen level and/or a high rate of change in hydrogen level may be activated. Furthermore, the blower speed of the venting blowers may be selected in such a manner that a high hydrogen level and/or a high rate of change in hydrogen level result is a higher blower speed than a somewhat lower hydrogen level and/or rate of change in hydrogen level. Thereby the selected blower speed corresponds to the need for venting the interior part of the tower.

The hydrogen transport line may be or comprise a double walled pipe, forming an inner pipe part in which hydrogen is transported and an outer pipe part arranged circumferentially with respect to the inner pipe part, and the emergency procedure may further comprise the step of flushing the outer pipe part with a venting gas.

The concept of the hydrogen transport line comprising a double walled pipe has already been described above with reference to the first aspect of the invention. According to this embodiment, the outer pipe, and thereby the space between the inner pipe and the outer pipe, is flushed as part of the emergency procedure. Thereby it is efficiently ensured that any hydrogen leaking from the inner pipe to the space between the inner pipe and the outer pipe is vented out of the wind turbine, and thereby prevented from entering the interior part of the tower from the outer pipe.

As described above with reference to the first aspect of the invention, the venting gas may be an inert gas, such as nitrogen, or it may be atmospheric air.

The emergency procedure may further comprise the step of activating a hydrogen warning indicator arranged at a door opening at the lower part of the tower or a door between the nacelle and a compartment with the electrolysis system.

According to this embodiment, a person wishing to enter the wind turbine, via the door opening at the lower part of the, is warned against doing so if an unsafe hydrogen level inside the tower has been detected. As described above with reference to the first aspect of the invention, the hydrogen warning indicator may be visible and/or audible, and activating the hydrogen warning indicator may be followed by the door being automatically locked, thereby physically preventing persons from entering the tower until a safe hydrogen level is restored.

The structural integrity of the tower of a wind turbine is essential in operating a wind turbine with an electrolyser system arranged in an up-tower part of the wind turbine. Particularly, the inventors realized that maintaining the structural integrity of the tower also after an—unlikely—explosion or fire of hydrogen is essential for the ability to safely repairing, decommissioning, and/or dismantling a wind turbine after such incident. Furthermore, the inventors found that combined approach towards reducing the risk of hydrogen leak, providing the ability to remove leaked hydrogen and maintain structural during and after a blast provides a synergetic reduction of the risk of transporting hydrogen inside the tower.

### BRIEF DESCRIPTION OF THE DRAWINGS

The invention will now be described in further detail with reference to the accompanying drawings in which

FIG. 1 is a perspective view of a wind turbine according to an embodiment of the invention,

FIG. 2 is a schematic cross sectional view of a tower for a wind turbine according to an embodiment of the invention,

FIG. 3 is a diagrammatic view of a wind turbine according to an embodiment of the invention, including an electrolysis system,

FIGS. 4a and 4b are cross sectional views of a wind turbine according to a first embodiment of the invention,

FIGS. 5a and 5b are cross sectional views of a wind turbine according to a second embodiment of the invention, and

FIGS. 6a and 6b are cross sectional views of a wind turbine according to a third embodiment of the invention.

### DETAILED DESCRIPTION OF THE DRAWINGS

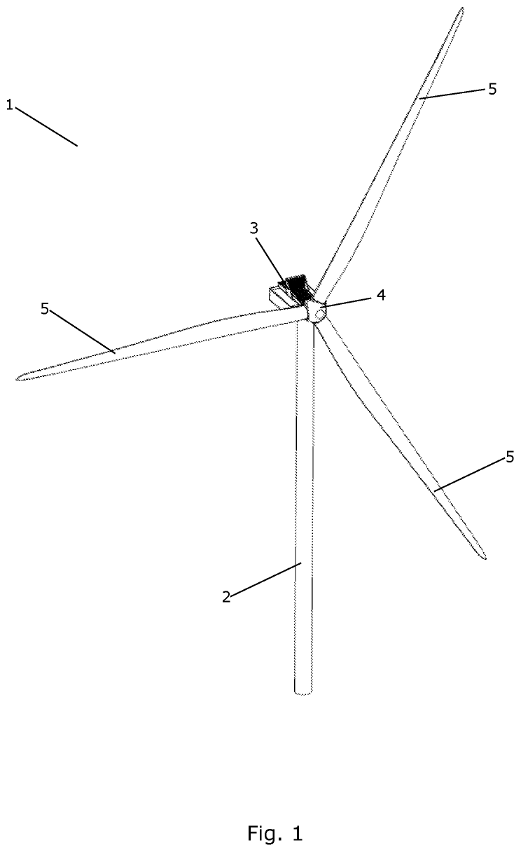

FIG. 1 is a perspective view of a wind turbine 1 according to an embodiment of the invention. The wind turbine 1 comprises a tower 2, a nacelle 3 mounted rotatably on the tower 2 and a hub 4 carrying three wind turbine blades 5.

The wind turbine 1 further comprises an electrolysis system (not shown) arranged in the nacelle 3, and electrically connected directly to a DC power output of an AC/DC converter (not shown) of the wind turbine 1, also arranged in the nacelle 3. Accordingly, the electrolysis system produces hydrogen, in the nacelle 3, using DC power produced by the wind turbine 1.

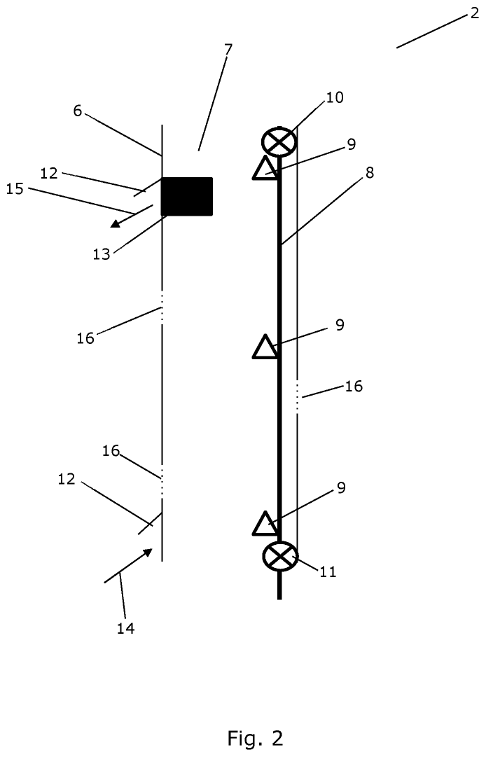

A hydrogen transport line (not shown) extends in an interior part of the tower 2 from the electrolysis system towards a lower part of the tower 2. Thereby hydrogen produced by the electrolysis system can be transported towards the ground. This will be described in further detail below with reference to FIG. 2.

FIG. 2 is a schematic cross sectional view of a tower 2 for a wind turbine according to an embodiment of the invention. A tower wall 6 delimits the tower 2, thereby defining an interior part 7 of the tower 2.

A hydrogen transport line 8 extends in the interior part 7 of the tower 2 between an electrolysis system (not shown) arranged in an up-tower part of the wind turbine, e.g. in the nacelle, and a lower part of the tower 2. Thereby hydrogen produced by the electrolysis system can be transported out of the wind turbine, via the hydrogen transport line 8.

A number of hydrogen sensors 9, three of which are shown, are arranged in the interior part 7 of the tower 2, and distributed along the length of the tower 2. The hydrogen sensors 9 are adapted to detect the presence of hydrogen in the interior part 7 of the tower 2, e.g. due to a leak in the hydrogen transport line 8. The hydrogen sensors 9 may be used for detecting a hydrogen level and/or a rate of change in hydrogen level in the interior part 7 of the tower 2. In the case that the detected hydrogen level and/or rate of change in hydrogen level exceeds a certain threshold value, indicating that unsafe conditions are occurring or approaching inside the tower 2, an emergency procedure can be initiated which at least prevents further increase of the hydrogen level in the interior part 7 of the tower 2, and which may further actively reduce the hydrogen level in the interior part 7 of the tower 2.

As a first step in the emergency procedure, the production of hydrogen by means of the electrolysis system is stopped. Thereby the source of hydrogen is stopped, and thereby also the continuous supply of hydrogen to the hydrogen transport line 8.

A first controllable valve 10 is arranged between the electrolysis system and an inlet of the hydrogen transport line 8. This allows the hydrogen transport line 8 to be isolated from the electrolysis system, and thereby from the source of hydrogen. The first controllable valve 10 may be closed as a part of the emergency procedure, thereby preventing any residual hydrogen remaining in the electrolysis system from entering the hydrogen transport line 8, and thereby potentially the interior part 7 of the tower 2, via a possible leak in the hydrogen transport line 8.

Similarly, a second controllable valve 11 is arranged at an outlet of the hydrogen transport line 8 towards an external hydrogen grid (not shown). This allows the hydrogen transport line 8 to be isolated from the external hydrogen grid, thereby preventing hydrogen from the external hydrogen grid from entering the hydrogen transport line 8, and thereby potentially the interior part 7 of the tower 2, via a potential leak in the hydrogen transport line 8. The second controllable valve 11 may also be closed as part of the emergency procedure.

The second controllable valve 11 may be replaced by a one-way valve which allows hydrogen from the hydrogen transport line 8 to enter the external hydrogen grid or the (local) storage facility, but prevents hydrogen from the external hydrogen grid or (local) storage facility from entering the hydrogen transport line 8.

The tower wall 6 is provided with a number of venting openings 12, two of which are shown. A venting blower 13 is mounted at the upper-most venting opening 12. When the venting blower 13 is activated, air is sucked into the interior part 7 of the tower 2, via the lower-most venting opening 12, as illustrated by arrow 14, and air is vented out of the tower via the upper-most venting opening 12, as illustrated by arrow 15. The venting blower 13 may be activated as part of the emergency procedure, thereby causing hydrogen present in the interior part 7 of the tower 2 to be vented to the exterior atmosphere. Furthermore, the speed of the venting blower may be controlled in accordance with the detected hydrogen level and/or rate of change in hydrogen level, thereby providing fast venting if this is required.

A number of blast panels 16, three of which are shown, are formed in the tower wall 6. In the case that an explosion occurs in the interior part 7 of the tower 2, due to accumulated hydrogen, the blast panels 16 will blow out, but damage to the rest of the structure of the tower 2 is substantially avoided.

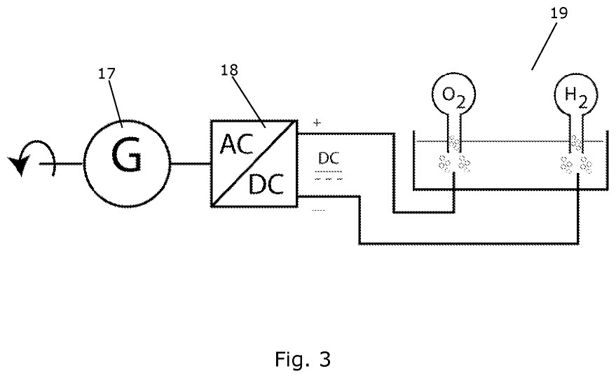

FIG. 3 is a diagrammatic view of a wind turbine according to an embodiment of the invention. A rotating system, driven by the wind turbine blades and the hub, is connected to a generator 17 which generates AC power from the mechanical energy of the rotating system. The AC power output of the generator 17 is connected to an AC/DC converter 18, where the AC power of the generator 17 is converted into DC power. The DC power output of the AC/DC converter 18 is connected to an electrolysis system 19, where the DC power is applied for producing hydrogen by electrolysis. A conversion system (not shown) for binding hydrogen to a LOHC, or in another energy carrier, such as methanol, ethanol or ammonia may be combined with the electrolysis system, and in this case, the hydrogen supplied by the electrolysis system to the hydrogen transport line is in the form of LOHC, methanol, ethanol, ammonia, or another hydrogen containing energy carrier.

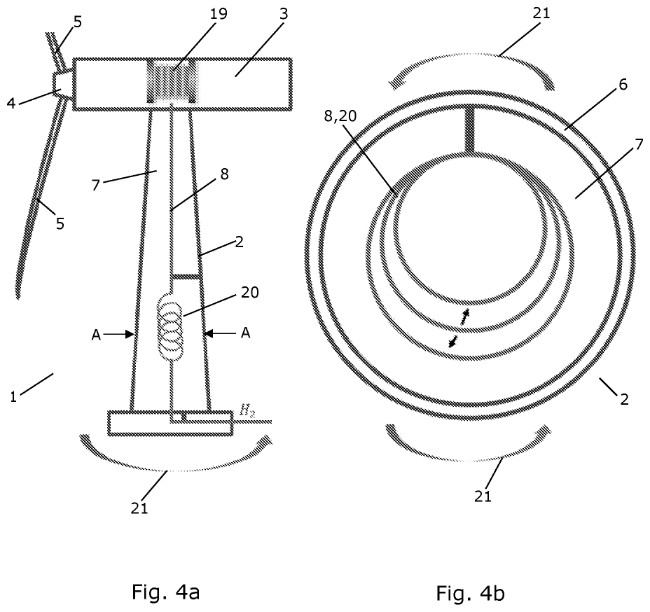

FIGS. 4a and 4b are cross sectional views of a wind turbine 1 according to a first embodiment of the invention. FIG. 4b is a cross section along line A-A illustrated in FIG. 4a. The wind turbine 1 comprises a tower 2 with a tower wall 6, a nacelle 3, a hub 4 and three wind turbine blades 5, two of which are shown. An electrolysis system 19 is arranged in the nacelle 3 for producing hydrogen, in the manner described above with reference to FIG. 3. A hydrogen transport line 8 extends in an interior part 7 of the tower 2 from the electrolysis system 19 towards an external hydrogen grid (not shown).

The hydrogen transport line 8 comprises a coiled portion 20. When the nacelle 3 performs yawing movements relative to the tower 2, as indicated by arrows 21, the part of the hydrogen transport line 8 which is connected to the electrolysis system 19 will be rotated along, thereby twisting or untwisting the part of the hydrogen transport line 8 which extends in the interior part 7 of the tower 2. This twisting or untwisting causes the coiled portion 20 of the hydrogen transport line 8 to contract or expand, as illustrated in FIG. 4b, i.e. the diameter of the coiled portion 20 is increased or decreased, depending on the direction of the yawing movement. Accordingly, the coiled portion 20 ‘absorbs’ the tension in the hydrogen transport line 8 without introducing sharp twists or bends of the hydrogen transport line which would otherwise be caused by the yawing movements, and thereby the risk of damage to the hydrogen transport line 8 during yawing is significantly reduced.

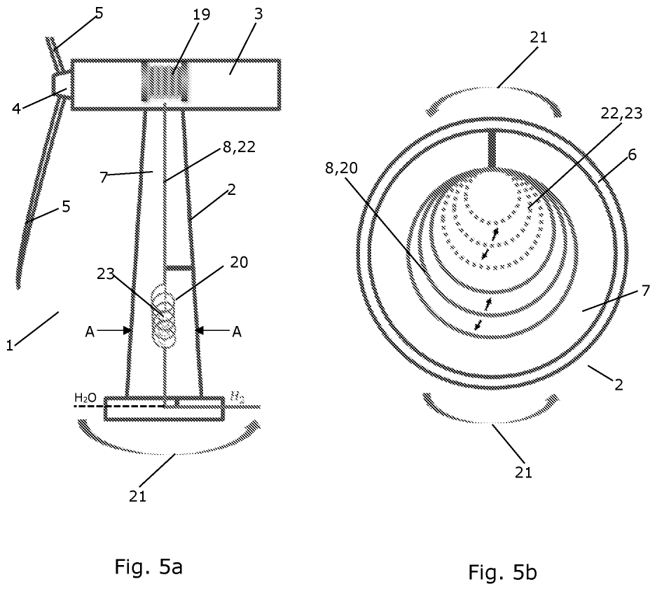

FIGS. 5a and 5b are cross sectional views of a wind turbine 1 according to a second embodiment of the invention. FIG. 5b is a cross section along line A-A illustrated in FIG. 5a. The wind turbine 1 of FIGS. 5a and 5b is very similar to the wind turbine 1 of FIGS. 4a and 4b, and it will therefore not be described in detail here. In FIGS. 5a and 5b, a water supply line 22 is further shown. The water supply line 22 supplies water to the electrolysis system 19 for use in the electrolysis process. The water supply line 22 also comprises a coiled portion 23, which contract or expands in the same manner as the hydrogen transport line 8 during yawing. In FIGS. 5a and 5b the coiled portions 20, 23 of the hydrogen transport line 8 and the water supply line 22, respectively, are arranged in an intertwined manner, at approximately the same level inside the tower 2.

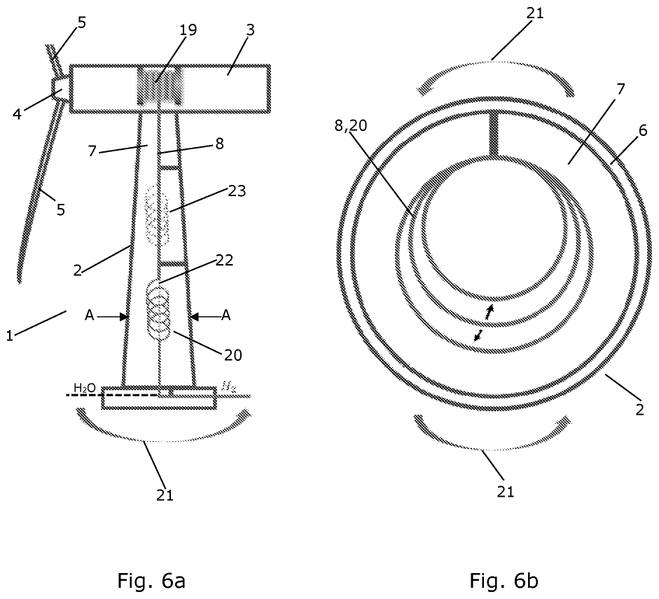

FIGS. 6a and 6b are cross sectional views of a wind turbine 1 according to a third embodiment of the invention. FIG. 6b is a cross section along line A-A illustrated in FIG. 6a. The wind turbine 1 of FIGS. 6a and 6b are very similar to the wind turbine 1 of FIGS. 5a and 5b, and it will therefore not be described in detail here. In FIGS. 6a and 6b, the coiled portion 20 of the hydrogen transport line 8 is arranged at a lower level inside the tower 2 than the coiled portion 23 of the water supply line 22.

In FIGS. 4-6, coils are shown in a helix type configuration, but it may alternatively be in a substantially flat configurations, so all coils are placed close to each other such as within 1 m in height. In this configuration, the space required for the transport line yawing system is highly reduced.

1. A wind turbine comprising a tower, a nacelle mounted rotatably on the tower via a yaw system and a hub carrying at least one wind turbine blade, the hub being mounted rotatably on the nacelle, the wind turbine further comprising a generator, an AC/DC converter connected to the generator and an electrolysis system connected to a DC power output of the AC/DC converter, the electrolysis system being arranged in an up-tower part of the wind turbine, wherein the wind turbine further comprises a hydrogen transport line connected to the electrolysis system for transporting hydrogen produced by the electrolysis system away from the electrolysis system, the hydrogen transport line extending in an interior part of the tower at least partly between the up-tower part of the wind turbine and a lower part of the tower, the wind turbine further comprising at least one hydrogen sensor arranged in the interior part of the tower.

2. The wind turbine according to claim 1, wherein the hydrogen transport line is provided with a one-way valve arranged at an outlet of the hydrogen transport line, at a lower part of the tower, the one-way valve allowing hydrogen to leave the hydrogen transport line towards an external hydrogen grid or storage but preventing hydrogen from the external hydrogen grid or storage from entering the hydrogen transport line.

3. The wind turbine according to claim 1, further comprising at least one blast panels formed in a wall of the tower, each blast panel being provided in a part of the tower wall which is provided with a reinforcement rim arranged circumferentially with respect to the blast panel.

4. The wind turbine according to claim 1, further comprising at least one controllable valve arranged between the electrolysis system and an inlet of the hydrogen transport line.

5. The wind turbine according to claim 1, further comprising an emergency hydrogen exit channel connected directly to the electrolysis system and/or the hydrogen transport line.

6. The wind turbine according to claim 1, further comprising at least one controllable venting blower arranged at a venting opening formed in a wall of the tower.

7. The wind turbine according to claim 1, wherein the hydrogen transport line is or comprises a double walled pipe, forming an inner pipe part in which hydrogen is transported and an outer pipe part arranged circumferentially with respect to the inner pipe part, preferably the wind turbine, further comprising an emergency flushing system for flushing the outer pipe part with a venting gas in the case of a hydrogen leak from the inner pipe part.

8. The wind turbine according to claim 1, wherein the electrolysis system is arranged inside the nacelle or in a closed, closable or sealable compartment connected to the nacelle.

9. The wind turbine according to claim 9, wherein a part of the hydrogen transport line which passes the yaw system is arranged outside the tower and the nacelle.

10. The wind turbine according to claim 1, wherein the hydrogen transport line comprises a coiled portion, and wherein a diameter of the coiled portion changes in response to yawing movements of the nacelle.

11. The wind turbine according to claim 1, further comprising a hydrogen warning indicator arranged at a door opening at the lower part of the tower, the hydrogen warning indicator being activated in case of hydrogen detection in the interior part of the tower.

12. A method for operating an electrolysis system and a hydrogen transport line forming part of a wind turbine, the wind turbine comprising a tower, a nacelle mounted rotatably on the tower via a yaw system, a generator and an AC/DC converter connected to the generator, the electrolysis system being arranged in an up-tower part of the wind turbine and being connected to a DC power output of the AC/DC converter, the hydrogen transport line extending in an interior part of the tower at least partly between the up-tower part of the wind turbine and a lower part of the tower, the method comprising:
producing hydrogen by means of the electrolysis system using DC power produced by the wind turbine and supplied to the electrolysis system from the DC power output of the AC/DC converter, and transporting the produced hydrogen from the electrolysis system towards the lower part of the tower by means of the hydrogen transport line arranged in the interior part of the tower,
monitoring a hydrogen level in the interior part of the tower by means of one or more hydrogen sensor arranged in the interior part of the tower, and
in the case that a hydrogen level exceeding a first threshold level and/or a rate of change in hydrogen level exceeding a second threshold level is detected, initiating an emergency procedure, the emergency procedure comprising stopping production of hydrogen by means of the electrolysis system.

13. The method according to claim 12, wherein the emergency procedure further comprises closing a controllable valve arranged between the electrolysis system and an inlet of the hydrogen transport line, thereby preventing hydrogen from entering the hydrogen transport line from the electrolysis system.

14. The method according to claim 12, wherein the emergency procedure further comprises opening an emergency hydrogen exit channel connected directly to the electrolysis system and/or the hydrogen transport line, thereby venting any residual hydrogen from the electrolysis system to the ambient atmosphere.

15. The method according to claim 12, wherein the emergency procedure further comprises controlling a blower speed of at least one controllable venting blower arranged at venting openings formed in a wall of the tower, thereby venting the interior part of the tower.

16. The method according to claim 13, wherein the hydrogen transport line is or comprises a double walled pipe, forming an inner pipe part in which hydrogen is transported and an outer pipe part arranged circumferentially with respect to the inner pipe part, and wherein the emergency procedure further comprises the step of flushing the outer pipe part with a venting gas.

17. The method according to claim 13, wherein the emergency procedure further comprises activating a hydrogen warning indicator arranged at a door opening at the lower part of the tower.
